(19) United States
(12) Patent Application Publication
(10) Pub. No.: US 2007/0046139 A1
(43) Pub. Date: Mar. 1, 2007

(54) Lundell type rotor core structure and rotary electric machine employing the same

(75) Inventor: Atsuo Ishizuka, Nagoya (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 11/506,868

(22) Filed: Aug. 21, 2006

(30) Foreign Application Priority Data
Aug. 26, 2005 (JP) 2005-246249
Apr. 17, 2006 (JP) 2006-113507

(51) Int. Cl. H02K 1/22

(52) U.S. Cl. 310/263

(57) ABSTRACT

A Lundell type rotor core structure and an electric rotary machine employing the same are disclosed. The rotor core structure has first and second claw pole portions alternately placed in a circumferential direction to define clearances each having a magnet mount position deviated from an axial center of each clearance and permanent magnets alternately disposed in the magnet mount positions of the clearances with respect to the axial direction of the rotor core structure for magnetizing the first and second claw pole portions in first and second magnetic polarities, respectively, wherein each of the permanent magnets allows a greater amount of magnetic fluxes to pass through one of the first and second claw pole portions than those passing through the other one of the first and second claw pole portions for minimizing harmonic component to suppress the magnetic sound.

### CROSS REFERENCE TO RELATED APPLICATIONS

This application is related to Japanese Patent Application Nos. 2005-246249 and 2006-113507 filed on Aug. 26, 2005 and Apr. 17, 2006, respectively, the contents of which are hereby incorporated by reference.

### BACKGROUND OF THE INVENTION

1. Technical Field of the Invention

The present invention relates to electric rotary machines of Lundell type rotors and, more particularly, to a Lundell type rotor core structure and an electric rotary machine employing such a Lundell type rotor core structure.

2. Description of the Related Art

In general, a vehicular alternator includes a Lundell type rotor core that is comprised of a pair of pole cores each including a boss portion allowing magnetic fluxes to pass in an axial direction in an area radially inward of a field coil, a disc portion (column portion) extending radially outward from the boss portion at an axial end thereof for passing the magnetic fluxes of the magnetic field in a radial direction and having a large number of claw pole portions axially extending from the disc portion so as to surround the field coil for passing the magnetic fluxes to and receiving the magnetic fluxes from a stator core. The claw pole portions of the first pole core and the claw pole portions of the second pole core are alternately placed along a circumferential periphery of the rotor. With the Lundell type rotor core in normal use, the pair of pole cores is manufactured of mass-like soft magnetic cores and the pole cores are axially combined into one piece so as to sandwich the field coil in assembly.

Attempts have heretofore been made to provide Lundell type rotor cores of intervening magnet types (each also referred to as a Lundell type rotor core combined with a magnet) each including a permanent magnet sandwiched between claw pole portions placed adjacent to each other along a circumferential periphery of a rotor core to intensify magnetic fluxes between the claw pole portions as disclosed in Japanese Patent Laid-Open Publication Nos. 2004-7958, 2002-262530, H10-4664, H10-201149, H10-4660, H10-4662, H10-4663 and 2005-237107.

The Lundell type rotor cores of the related art, mentioned above, have been known to have an issue with the occurrence of an increased magnetic sound resulting from a third harmonic component. Decreasing the harmonic component of the magnetic fluxes can reduce the magnetic sound and, hence, it is conceived that contriving a shape or placement of the claw pole portions allows reduction in the harmonic component of the magnetic fluxes for thereby minimizing the magnetic sound.

However, it has been a usual practice for manufacturing the pair of pole cores, forming the Lundell type rotor core, by forging and, when manufacturing claw pole portions with too complicated a configuration, an issue arises with a manufacturing process being complicated.

Further, among the related arts listed above, Japanese Patent Laid-Open Publication No. 2005-237107 proposes to provide a Lundell type rotor core wherein a permanent magnet is disposed in a claw type magnetic pole at one side thereof with respect to a rotational direction of the rotor core. However, upon tests conducted by the present inventors, it has been discovered that such a related art structure still has an increased third harmonic component, causing a major component of the magnetic sound, in the magnetic fluxes.

### SUMMARY OF THE INVENTION

The present invention has been completed with a view to addressing the above issues and has an object to provide a Lundell type rotor core structure and an electric rotary machine employing such a Lundell type rotor core structure.

To achieve the above object, one aspect of the present invention provides a rotor core structure for an electric rotary machine. The rotor core structure comprises a first pole core having a boss portion on which a field coil is wound to allow field magnetic fluxes to flow in an axial direction of the rotor core structure and having claw pole portions axially extending for surrounding the field coil. The rotor core structure further comprises a second pole core having a boss portion on which the field coil is placed to allow the field magnetic fluxes to flow in the axial direction and having claw pole portions axially extending for surrounding the field coil. The claw pole portions of the first and second pole cores are alternately placed along a circumferential periphery of the rotor core structure to define clearances each having a magnet mount position deviated from an axial center of each clearance. Permanent magnets are alternately disposed in the clearances with respect to the axial direction of the rotor core structure for magnetizing the claw pole portions in first and second magnetic polarities, respectively. Each of the permanent magnets allows a greater amount of magnetic fluxes to pass through one of the claw pole portions of the first pole core than that of the magnetic fluxes passing through an adjacent one of the claw pole portions of the second pole core.

With such a structure set forth above, the permanent magnet allows one side of each claw pole portion, oriented in a circumferential direction of the rotor core structure, to pass the greater amount of magnetic fluxes than that of the magnetic fluxes passing through the other side of each claw pole portion. It has turned out that such a structure results in the cancellation of a harmonic component of the magnetic field on an outer periphery of the rotor core structure facing an inner periphery of a stator with a reduction in the magnetic sound.

Such an advantage is more clearly described below in comparison to the related art alternator having a Lundell type rotor core that is rotatably supported inside a stator core. The related art alternator takes a structure wherein magnetic fluxes, flowing from the Lundell type rotor core to the stator core, have a harmonic component and, hence, a magnetic field is distorted. Such a harmonic component in the magnetic field causes a harmonic component to occur in magnetic forces acting on teeth of the stator core in radial and circumferential directions of the rotor core. This results in vibration of the teeth at high frequencies to cause a magnetic sound to be output. An electric angle π is occupied in a distance between centers of circumferential gaps formed adjacent to both sides of one claw pole portion in a fore and aft direction along a circumferential periphery of the rotor core. Accordingly, if no harmonic component is present in the magnetic field, a magnetic field distribution pattern of an electromagnetic gap along a circumferential direction would be bound to take a sine wave configuration due to the electric angle π starting from a circumferential center point of the clearance of one claw pole portion and ending at a circumferential center point of the clearance of the other claw pole portion adjacent to the one claw pole portion. However, upon actual measurements conducted by the present inventors, due to a surface profile of the claw pole portion facing the stator core, a circumferential half area of one claw pole portion creates a magnetic field with a higher intensity in the electromagnetic gap than that of a magnetic field created by the other half area of this claw pole portion.

The present invention has been completed on the ground of expertise in that an electromagnetic gap associated with a claw pole portion has a magnetic flux pattern distorted along a circumferential periphery of a rotor core. Of one half area of the claw pole portion and the other half area thereof, the one half area of the claw pole portion having a weakened magnetic field in the electromagnetic gap causing a harmonic component to take place is caused to have increased magnetic fluxes upon utilizing a permanent magnet disposed between the claw pole portions. This enables a reduction in distortion of a waveform of the magnetic field caused in areas on both sides of a circumferentially center point of the claw pole portion, enabling a harmonic component such as, for instance, a third harmonic component, of the magnetic field to be minimized. This results in a reduction of vibrations of the teeth, resulting from the harmonic component of the magnetic field causing a magnetic sound in a harsh frequency band, and the magnetic sound can be minimized in a favorable fashion.

With the rotor core structure mentioned above, each of the permanent magnets may be placed in the magnet mount position at an area circumferentially closer to one side of each of the claw pole portions of the first and second pole cores. Such a structure enables the one side of each claw pole portion to have a magnetic flux region (prevailing at an outer peripheral surface area facing the stator core) with a higher magnetic flux density than that of a magnetic flux region of the other side of each claw pole portion, that is, on a side far from the permanent magnet. Accordingly, by locating the permanent magnet in the clearance at a position close of proximity to the one half area of each claw pole portion where distortion occurs in the waveform of the magnetic field, the electromagnetic gap can have a magnetic field pattern that is made closer to a sine wave, enabling the suppression of a magnetic sound in a simplified structure.

The rotor core structure may further comprise spacers disposed in the clearances in association with the permanent magnets, respectively, and each having low magnetic flux permeability. Such a structure enables a pair of the claw pole portions adjacent to each other in the circumferential direction of the rotor core structure to mechanically support the permanent magnet and the spacer in a fixed place with increased reliability. This prevents the vibration of the permanent magnet and a drop-off of the permanent magnet from the rotor core due to centrifugal force, resulting in capability of strengthening a structure of the rotor core. For the spacer, resin material, non-magnetic material or soft magnetic material having saturable magnetic properties may be employed. In addition to such materials, a spring material may be used as the spacer for elastically urging the permanent magnet in the circumferential direction of the rotor core structure.

With the rotor core structure set forth above, each of the spacers may be made of non-magnetic material. This enables the improvement in an effect of correcting the magnetic field of the electromagnetic gap through the use of the magnetic field of the permanent magnet.

With the rotor core structure set forth above, each of the spacers may be integrally formed with a magnet protection cover that covers each of the permanent magnets. This enables the spacer or the permanent magnet to be favorably supported in a space between the adjacent claw pole portions.

With the rotor core structure set forth above, each of the spacers is incorporated in a magnet protection cover that covers each of the permanent magnets. This results in capability of mechanically supporting the spacer or the permanent magnet to be favorably supported in the space between the adjacent claw pole portions.

With the rotor core structure set forth above, the clearances may obliquely extend from one axial end of the rotor core structure toward the other axial end thereof, and each of the permanent magnets may have a longitudinal axis shorter than a longitudinal axis of each of the clearances and located in a position dislocated from a center position of each of the clearances by a given angle in the circumferential direction of the rotor core structure. This structure enables a reduction in a harmonic component of the magnetic field on an outer peripheral surface of the rotor core structure facing an inner peripheral surface of a stator core.

With such a structure, further, the permanent magnet is placed in the clearance such that a circumferential center point of the permanent magnet is placed in a position dislocated from an intermediate point between the adjacent claw pole portions by a given angle. Preferably, the permanent magnet is placed in the clearance at an area deviated to an apex portion of the claw pole portion substantially configured in a rectangular shape as viewed in a radial direction of the rotor core structure. Such a structure results in a reduction in the harmonic component of the magnetic field on the outer peripheral surface of the rotor core facing the inner peripheral surface of the stator core.

With the rotor core structure set forth above, the permanent magnets in odd number with respect to the circumferential direction of the rotor core structure and the permanent magnets in even number with respect to the circumferential direction may be alternately located in areas displaced by a given distance in the axial direction of the rotor core structure. Such a structure is effective for minimizing the harmonic component in the magnetic field with the resultant suppression of the magnetic sound in a simplified structure.

Another aspect of the present invention provides an electric rotary machine, comprising a housing, a stator supported by the housing, and a Lundell type rotor core rotatably supported by the housing inside the stator. The Lundell type rotor core comprises a first pole core having a boss portion on which a field coil is wound to allow field magnetic fluxes to flow in an axial direction of the rotor core and having first claw pole portions axially extending for surrounding the field coil, and a second pole core having a boss portion on which the field coil is placed to allow the field magnetic fluxes to flow in the axial direction and having second claw pole portions axially extending for surrounding the field coil, wherein the first and second claw pole portions are alternately placed along a circumferential periphery of the rotor core structure to define clearances each having a magnet mount position deviated from an axial center of each clearance. Permanent magnets are alternately disposed in the clearances with respect to the axial direction of the rotor core for magnetizing the first and second claw pole portions in first and second magnetic polarities, respectively. Each of the permanent magnets allows a greater amount of magnetic fluxes to pass through one of the first and second claw pole portions than those passing through the other one of the first and second claw pole portions.

With such a structure set forth above, the electromagnetic gap can have a magnetic field pattern that is made closer to a sine wave, enabling the suppression of the magnetic sound in a simplified structure.

### BRIEF DESCRIPTION OF THE DRAWINGS

In the accompanying drawings:

FIG. 1 is a cross-sectional view of an overall structure of a vehicle alternator incorporating a Lundell type rotor core structure of one embodiment according to the present invention;

FIG. 2 is a perspective view of the rotor core structure shown in FIG. 1;

FIG. 3 is an enlarged cross-sectional view, taken on a plane along a radial direction of the rotor core structure shown in FIG. 2;

FIG. 4 is a cross-sectional view showing an example of a unitary structure between a permanent magnet and a spacer;

FIG. 5 is a cross-sectional view showing another example of a unitary structure between a permanent magnet and a spacer;

FIG. 6 is a cross-sectional view showing still another example of a unitary structure between a permanent magnet and a spacer;

FIG. 7A is a schematic view showing the relationship between permanent magnets and associated claw pole portions forming a rotor core structure of a modified form; and

FIG. 7B is a view showing how a distorted waveform of a magnetic field in an electromagnetic gap between the rotor core structure and a stator core is corrected.

### DETAILED DESCRIPTION OF PREFERRED EMBODIMENTS

A Lundell type rotor core structure of a rotary electric machine according to the present invention is described below in detail with reference to the accompanying drawings. However, the present invention is construed not to be limited to the embodiment described below and a technical concept of the present invention may be implemented in combination with other known technologies or the other technology having functions equivalent to such known technologies.

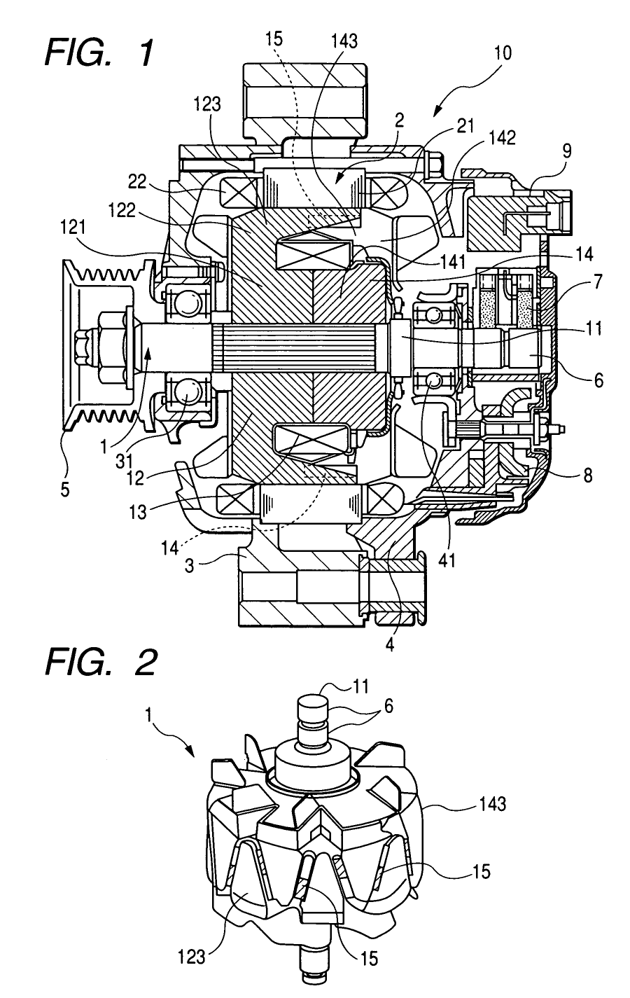

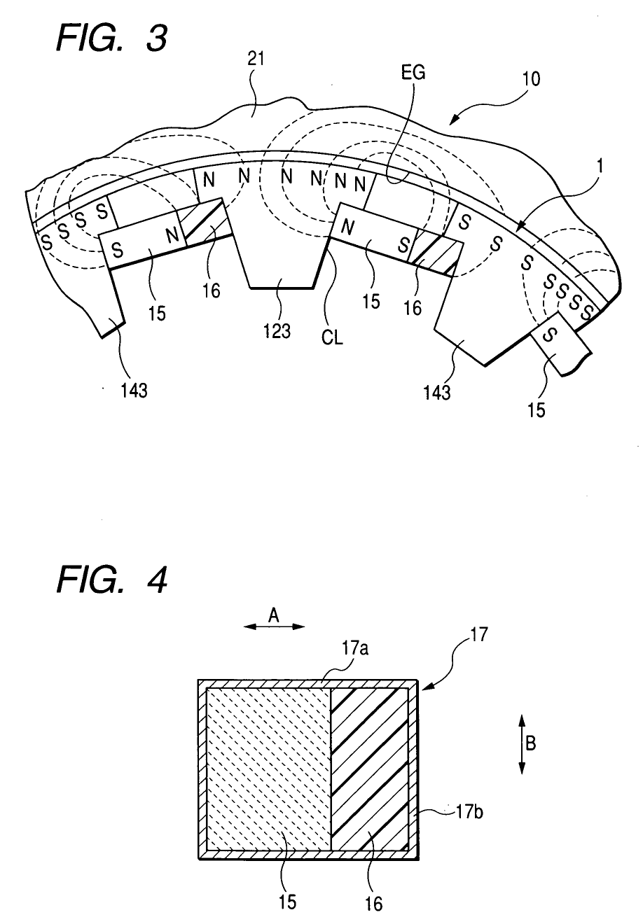

FIG. 1 shows a vehicle alternator, playing a role as an electric rotary machine, which has a Lundell-type rotor core structure of a first example according to the present invention. FIG. 2 is a perspective view of the rotor core structure incorporated in the vehicle alternator shown in FIG. 1 and FIG. 3 is an enlarged partial view showing the relationship between permanent magnets and associated claw pole portions of the rotor core structure shown in FIG. 2.

As shown in FIG. 1, the vehicle alternator 10 is comprised of a rotor core structure (assembly) 1, a stator 2, a front frame 3 and a rear frame 4 by which a housing is formed, a pulley 5, a slip-ring 6, a brush structure 7, a rectifier 8 and a regulator 9.

The stator 2 includes a stator core 21 carrying thereon stator coils 22 and is fixedly secured to inner peripheral surfaces of the front frame 3 and the rear frame 4. The front frame 3 and the rear frame 4 are coupled to each other by means of a plurality of bolts intervening the stator 2 and carry bearings 31, 41 by which a rotary shaft 11 of the rotor core structure 1 is rotatably supported.

The rotor core structure 1 includes a front pole core 12, a filed winding (hereinafter referred to as an excitation coil) 13, a rear pole core 14 and permanent magnets 15. The pole cores 12, 14 have the same shapes as those of a pair of a Lundell type rotor core of the related art. More particularly, the pole core 12 is comprised of a boss portion 121 fixedly mounted on the rotor shaft 1 to be rotatable therewith, a disc portion 122 radially and outwardly extending from the boss portion 121 at a front end thereof, and a plurality of claw pole portions 123 axially extending rearward from an outer peripheral portion of the disc portion 122 at a radially outward end thereof, with the pole core 14 having the same configuration as that of the pole core 12. However, the pole core 14 has a boss portion 141, a disc portion 142 radially outwardly extending from the boss portion 141, and a plurality of claw pole portions 143 axially extending forward from an outer peripheral portion of the disc portion 142 at a radially outward end thereof. A rear end face of the pole core 12 and a front end face of the pole core 14 are held in contact with each other. The excitation coil 13 is surrounded with the pole cores 12, 14. The disc portions 122, 142 are integrally formed with the boss portions 121, 141, respectively. The pole cores 12, 14 are made of soft iron bodies. Also, in actual practice, the disc portions 122, 142 have eight concave and convex portions in conformity to the eight claw pole portions, respectively, and are configured in shape in a way to have eight radiated column portions. As is well known in the art, the claw pole portions 123 of the pole core 12 and the claw pole portions 143 of the pole core 14 are alternately disposed along a circumferential periphery of the rotor core structure 1.

FIG. 3 is a cross-sectional view, taken on a plane along a radial direction, of a central area of the rotor core structure 1 shown in FIG. 2. The rotor core structure 1 is shown in FIG. 2 with the permanent magnets 15 being shown in a typical arrangement in shape and placement. It will be appreciated that the permanent magnet 15 has a shape similar to that shown in FIG. 3 and placed in a fixed position as shown in FIG. 3.

As shown in FIGS. 2 and 3, a pair of the permanent magnet 15 and a spacer 16, made of non-magnetic material, is disposed in a clearance CL between the claw pole portion 123 of the first pole core 12 and the claw pole portion 143 of the second pole core 14, all of which are disposed at equidistantly spaced positions with a fixed pitch along a circumferential periphery of the rotor core structure 1. The permanent magnet 15 is magnetized in a circumferential direction (correctly in a tangential direction) of the rotor core structure 1.

As shown in FIG. 3, the clearance CL has a magnet mount position deviated from an axial center of the clearance CL between both axial ends of the rotor core structure 1. The permanent magnets 15 are disposed in the clearances CL, respectively, to be alternately closer to one end and the other end of the rotor core structure 1. Each of the permanent magnets 15 has a pair of magnetic pole surfaces one of which is held in abutting contact with a right end face of the claw pole portion 123 or the claw pole portion 143 and the other one of which is held in abutting contact with a left end face of the claw pole portion 143 or the claw pole portion 123 via the spacer 16. The spacer 16 is made of non-magnetic material such as plastic resin in this embodiment.

With such a layout of the permanent 15 and the spacer 16, circumferentially spaced both sides of the claw pole portion 123 or the claw pole portion 143 have magnetic flux distributions with different magnetic flux densities in contrast to magnetic flux distributions of the claw pole portion with a structure in which the spacer 16 is replaced by the permanent magnet 15. That is, an example of the magnetic flux distribution pattern, resulting from the permanent magnet 15, is designated in a broken line in FIG. 3.

Due to the presence of the spacer 16 associated with the permanent magnet 15 fitted in the clearance CL between the adjacent claw pole portions 123, 143, left sides of the claw pole portions 123, 143 have magnetic flux densities lower than those of right sides of the claw pole portions 123, 143 in the magnetic flux distribution shown in FIG. 3. This is due to the fact that as shown in FIG. 3, a magnetic flux leakage occurs to cause a portion of the magnetic fluxes of the permanent magnet 15 to directly pass through the stator core 21 from the permanent magnet 15 at a magnetic pole surface (an outer peripheral surface of the rotor core structure 1 facing the stator core 21) of the rotor core structure 1 without intervening the left side of the claw pole portion as viewed in FIG. 3.

As a result, of magnetic pole surfaces of the claw pole portion 123 or 143, the right magnetic pole surface (oriented in a clockwise direction of the rotor core structure 1 with respect to a center thereof as viewed in FIG. 3) in the right half of the claw pole portion 123 or 143 has a higher magnetic flux density than that of the left half (oriented in a counterclockwise direction of the rotor core structure 1 respect to the center thereof as viewed in FIG. 3) of the claw pole portion 123 or 143. Thus, the lessened magnetic flux density at the left half (oriented in the clockwise direction of the rotor core structure 1 as viewed in FIG. 3) of the claw pole portion 123 or 143 can be compensated. That is, a magnetic field in an electromagnetic gap EG between the stator core 21 and the claw pole portion 123 or 143 can be caused to approach to a sine wave configuration, with the resultant capability of reducing radiated harmonic vibrations of teeth for thereby minimizing a high harmonic component of the magnetic sound.

The spacer 16 may be formed of non-magnetic material or raw material with a low magnetic characteristic, that is, magnetic permeability and may be made of, for instance, non-magnetic metal or soft magnetic metal provided with a magnetic flux path in a small cross-sectional area.

FIG. 4 shows a modified form of the rotor core structure of the first embodiment. With this modification, a magnet protection cover 17 surrounds the permanent magnet 15 and the spacer 16 in one piece. As shown in FIG. 4, the magnet protection cover 17 has laterally extending horizontal walls 17a aligned in a circumferential direction A of the rotor core structure and vertically extending walls 17b aligned in a radial direction B. With such a structure, the magnet protection cover 17 can protect the permanent magnet 15 from damage resulting from an impact against an obstacle while further improving the integrity of the permanent magnet 15 and the spacer 16.

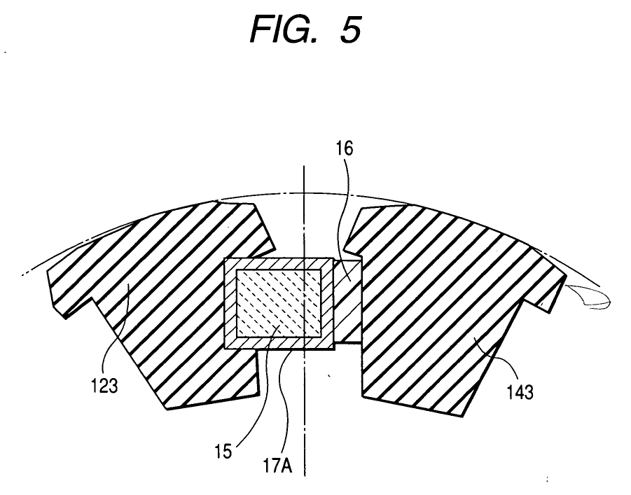

The magnet protection cover 17 may be manufactured using any of resin, non-magnetic metal and soft magnetic metal. As shown in FIG. 5, the magnet protection cover 17 may be replaced by a modified magnet protection cover 17A made of any material listed above in a structure to cover only the permanent magnet 15. With such a configuration, the spacer 16 is held in contact with a radiated face of the magnet protection cover 17A to assume a position between the radiated face of the magnet protection cover 17A and a radiated face of the claw pole portion 143.

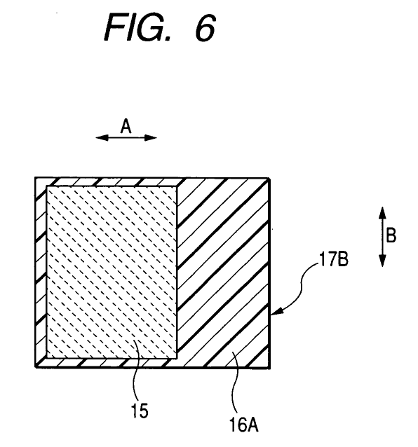

In another alternative, a magnet protection cover 17B may be employed in a structure shown in FIG. 6. In this modification, the magnet protection cover 17B is formed in a unitary structure with a spacer 16A and covers the permanent magnet 15 in a unitary structure. The magnet protection cover 17B has horizontal and vertical walls extending along the arrows A and B, respectively, in the same manner as shown in FIG. 4. Thus, the magnet protection cover 17B is integrally formed with the spacer 16A in a box-like configuration to incorporate the associated permanent magnet 15.

In a further alternative, the spacer 16 may include an elastic body such as an elastic member that elastically urges the permanent magnet 15 in a tangential direction.

In a still further alternative, the permanent magnet 15 may be disposed in a full area of the clearance between the claw pole portions 123, 143 in the same structure as that of the related art while removing the spacer 16 upon which a partial area of the permanent magnet 15 in the vicinity of one side of the claw pole portion 123 or 143 is subjected to heating treatment such as, for instance, laser heating to have deteriorated magnetic property so as to obtain the same effect as that of the structure shown in FIG. 3.

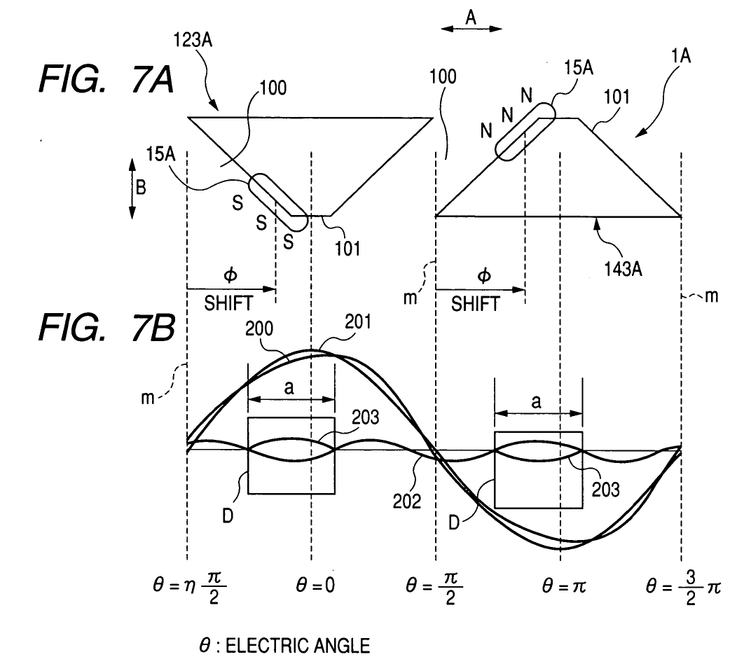

A vehicle alternator incorporating a rotor core structure 1A of a modified form according to the present invention is described with reference to typically illustrative views shown in FIGS. 7A and 7B. The rotor core structure 1A is identical to the rotor core structure 1 of the first embodiment and the same component parts bear like reference numerals to omit redundant description.

FIG. 7A is a development view of the rotor core structure 1A for illustrating structural shapes and placements of a first claw pole portion 123A, a second claw pole portion 143A and permanent magnets 15A. FIG. 7B is a view showing a magnetic distribution pattern in a circumferential direction of the rotor core structure 1A resulting from the first and second claw pole portions 123A, 143A.

The permanent magnet 15A has a longitudinal axis (length) shorter than those of the first and second claw pole portions 123A, 143A.

Each permanent magnet 15A is disposed in the clearance 100 between the claw pole portions 123A, 143A, extending from one axial and to the other axial end of the rotor core structure 1A and placed adjacent to each other in a circumferential direction A of the rotor core structure 1A, such that each permanent magnet 15A is shifted from a center line “m” (at an electrical angle of θ=π/2 or π/2 in an exemplary structure shown in FIG. 7B) of the clearance 100 between the claw pole portions 123A, 143A to a position circumferentially deviated by a given angle θ. Stated another way, one permanent magnet 15A in odd number in respect of the circumferential direction A is placed in one clearance 100 at a position closer to an apex portion of one claw pole portion on a side near the one axial end of the rotor core structure 1A and another permanent magnet 15A in even number in respect of the circumferential direction A is placed in another clearance 100 at a position closer to an apex portion of another claw pole portion on a side near the other axial end of the rotor core structure 1A. That is, one permanent magnet 15A in odd number in the circumferential direction A is disposed in one clearance 100 at a position closer to one of the adjacent claw pole portions 123A, 143A and another permanent magnet 15A in even number in the circumferential direction A is disposed in another clearance 100 at another position closer to the other one of the adjacent claw pole portions 123A, 143A to be remote from the one permanent magnet 15A.

The one permanent magnet 15A in odd number in the circumferential direction A and the another permanent magnet 15A in even number in the circumferential direction A are disposed at positions axially displaced in an axial direction B by a given distance. In other words, the one permanent magnet 15A in odd number in the circumferential direction A is placed in an area of the claw pole portion 143A at a position closer to the one axial end of the rotor core structure 1A. In contrast, the other permanent magnet 15A in even number in the circumferential direction A is placed in an area of the claw pole portion 123A at a position closer to the other axial end of the rotor core structure 1A.

More particularly, the permanent magnets 15A, 15A are dislocated toward the apex portions 101 of the adjacent claw pole portions 123A, 143A, respectively, which are arrayed in the circumferential direction A of the rotor core structure 1A. Also, while the respective permanent magnets 15A are placed in association with or closer to the respective claw pole portions 123A, 143, each at one side thereof in the circumferential direction A of the rotor core structure 1A as previously noted, the important point is that each permanent magnet 15A is placed in the clearance 100 in an area closer to or in the vicinity of one of side surfaces of each claw pole portion at a location operative to reduce a third harmonic component of a magnetic sound. Such an aspect is described below in detail.

FIG. 7B shows a magnetic field in an electromagnetic gap between the stator core and the rotor core structure 1A mentioned above. In a magnetic field waveform diagram shown in FIG. 7B, a curve 200 represents the magnetic field in the electromagnetic gap between the stator core and the rotor core in the absence of a permanent magnet placed in a particular position of the clearance to avoid the harmonic component. Due to the presence of a third harmonic component 202 with a fairly large magnitude with respect to a basic waveform component, the magnetic field 200 has a distorted waveform pattern. In contrast, since each permanent magnet 15A has a particular shape and arranged in a particular layout as shown in FIG. 7A, the magnetic field has a waveform 201 in a sine-wave and, so, the magnetic field in the electromagnetic gap between the stator core and the rotor core structure has minimized harmonic component.

Thus, by locating each permanent magnet 15A, with a longitudinal axis shorter than an axial length of the rotor core structure 15A, in an area “a” (that is, a region D at which a harmonic component is to be minimized from a magnetic field) dislocated from the center of the clearance in the circumferential direction A by the given distance, the magnetic field 200 is added with a locally increased magnetic field in a phase opposite to the third harmonic component 202 of the magnetic field and with the same frequency component as that of the harmonic component. This results in capability of remarkably canceling the third harmonic component 202 of the magnetic field 200.

That is, the magnetic field 200 has the region D (in which the third harmonic component 202 has a negative amplitude), surrounded by a thin solid line in the circumferential direction with the width “a” shown in FIG. 7B, in which the magnetic fluxes are locally increased to result in the magnetic field 201. This enables the third harmonic component 202 of the magnetic field in the electromagnetic gap to be favorably cancelled and enables the waveform 200 of the magnetic field in a radial direction to be closer to a basic waveform with less distortion to enable a reduction in a magnetic sound.

Stated another way, as shown in FIG. 7A, since the permanent magnet 15A is disposed in the clearance 100 at only partially occupied area dislocated from the center of the clearance 100 in the circumferential direction A of the rotor core structure 1A, the magnetic field of the electromagnetic gap between the stator core and the rotor core structure can be intensified in a locally limited area. Thus, by locating the permanent magnet in the clearance at the area dislocated in the circumferential direction A of the rotor core structure 1A so as to permit a portion of the magnetic field in the electromagnetic gap to be intensified in a phase opposite to a half wave of the third harmonic wave of the magnetic field in the electromagnetic gap, the third harmonic wave can be favorably cancelled.

That is, with the present embodiment, the clearance 100 between the adjacent claw pole portions 123a, 143a is obliquely formed with respect to the axis of the rotor core structure 1A and the clearances 100 are juxtaposed at circumferentially equidistantly spaced positions. Further, the permanent magnet 15A is set to have the longitudinal axis shorter than the axial length of each of the claw pole portions 123a, 143a. Furthermore, one permanent magnet 15A in odd number in respect of the circumferential direction A is disposed in one clearance 100 at an area dislocated in the circumferential direction A and closer to the one axial end of the rotor core structure 1A. On the contrary, the other permanent magnet 15A in even number in respect of the circumferential direction A is disposed in the other clearance 100 at an area dislocated in the circumferential direction A and closer to the other axial end of the rotor core structure 1A. Thus, the permanent magnet 15A is placed in the clearance 100 at the circumferentially deviated position thereof in phase opposite to a half wave of the third harmonic wave in the magnetic field of the electromagnetic gap described above, enabling the third harmonic wave to be favorably cancelled.

While the specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention, which is to be given the full breadth of the following claims and all equivalents thereof.

What is claimed is:

1. A rotor core structure for an electric rotary machine, comprising:
a first pole core having a boss portion on which a field coil is wound to allow field magnetic fluxes to flow in an axial direction of the rotor core structure and having claw pole portions axially extending for surrounding the field coil;
a second pole core having a boss portion on which the field coil is placed to allow the field magnetic fluxes to flow in the axial direction and having claw pole portions axially extending for surrounding the field coil, wherein the claw pole portions of the first and second pole cores are alternately placed along a circumferential periphery of the rotor core structure to define clearances each having a magnet mount position deviated from an axial center of each clearance;
permanent magnets alternately disposed in the magnet mount positions of the clearances with respect to the axial direction of the rotor core structure for magnetizing the claw pole portions in first and second magnetic polarities, respectively;
wherein each of the permanent magnets allows a greater amount of magnetic fluxes to pass through one of the claw pole portions of the first pole core than that of the magnetic fluxes passing through an adjacent one of the claw pole portions of the second pole core.

2. The rotor core structure according to claim 1, wherein:
each of the permanent magnets is placed in the magnet mount position at an area circumferentially closer to one side of each of the claw pole portions of the first and second pole cores.

3. The rotor core structure according to claim 1, further comprising:
spacers disposed in the clearances in association with the permanent magnets, respectively, and each having a low magnetic flux permeability.

4. The rotor core structure according to claim 3, wherein:
each of the spacers is made of non-magnetic material.

5. The rotor core structure according to claim 3, wherein:
each of the spacers is integrally formed with a magnet protection cover that covers each of the permanent magnets.

6. The rotor core structure according to claim 3, wherein:
each of the spacers is incorporated in a magnet protection cover that covers each of the permanent magnets.

7. The rotor core structure according to claim 2, wherein:
the clearances obliquely extend from one axial end of the rotor core structure toward the other axial end thereof; and
each of the permanent magnets has a longitudinal axis shorter than a longitudinal axis of each of the clearances and located in a position dislocated from a center position of each of the clearances by a given angle in the circumferential direction of the rotor core structure.

8. The rotor core structure according to claim 7, wherein:
the permanent magnets in odd number with respect to the circumferential direction of the rotor core structure and the permanent magnets in even number with respect to the circumferential direction are alternately located in areas displaced by a given distance in the axial direction of the rotor core structure.

9. An electric rotary machine, comprising:
a housing;
a stator supported by the housing; and
a Lundell type rotor core rotatably supported by the housing inside the stator;
the Lundell type rotor core comprising:
a first pole core having a boss portion on which a field coil is wound to allow field magnetic fluxes to flow in an axial direction of the rotor core and having claw pole portions axially extending for surrounding the field coil;
a second pole core having a boss portion on which the field coil is placed to allow the field magnetic fluxes to flow in the axial direction and having claw pole portions axially extending for surrounding the field coil, wherein the claw pole portions of the first and second pole cores are alternately placed along a circumferential periphery of the rotor core to define clearances each having a magnet mount position deviated from an axial center of each clearance;
permanent magnets alternately disposed in the magnet mount positions of the clearances, respectively, with respect to the axial direction of the rotor core for magnetizing the claw pole portions in first and second magnetic polarities, respectively;
wherein each of the permanent magnets allows a greater amount of magnetic fluxes to pass through one of the claw pole portions of the first pole core than that of the magnetic fluxes passing through an adjacent one of the claw pole portions of the second pole core.

10. The electric rotary machine according to claim 9, wherein:
each of the permanent magnets is placed in the magnet mount position at an area circumferentially closer to one side of each of the claw pole portions of the first and second pole cores.

11. The electric rotary machine according to claim 9, further comprising:
spacers disposed in the clearances in association with the permanent magnets, respectively, and each having a low magnetic flux permeability.

12. The electric rotary machine according to claim 11, wherein:
each of the spacers is made of non-magnetic material.

13. The electric rotary machine according to claim 11, wherein:
each of the spacers is integrally formed with a magnet protection cover that covers each of the permanent magnets.

14. The electric rotary machine according to claim 11, wherein:
each of the spacers is incorporated in a magnet protection cover that covers each of the permanent magnets.

15. The electric rotary machine according to claim 10, wherein:
the clearances obliquely extend from one axial end of the rotor core structure toward the other axial end thereof; and
each of the permanent magnets has a longitudinal axis shorter than a longitudinal axis of each of the clearances and located in a position dislocated from a center position of each of the clearances by a given angle in the circumferential direction of the rotor core structure.

16. The electric rotary machine according to claim 15, wherein:
the permanent magnets in odd number with respect to the circumferential direction of the rotor core structure and the permanent magnets in even number with respect to the circumferential direction are alternately located in areas displaced by a given distance in the axial direction of the rotor core structure.
